(19) United States
(12) Patent Application Publication
(10) Pub. No.: US 2017/0064792 A1
(43) Pub. Date: Mar. 2, 2017

(54) COPLANAR ELECTRODE ARRANGEMENT FOR ELECTROLUMINESCENT DEVICES

(71) Applicant: AhuraTech LLC, Howell, MI (US)

(72) Inventor: Ehsan YAKHSHI-TAFTI, Howell, MI (US)

(21) Appl. No.: 15/252,608

(22) Filed: Aug. 31, 2016

Related U.S. Application Data
(60) Provisional application No. 62/212,055, filed on Aug. 31, 2015.

(51) Int. Cl. H05B 33/14; H05B 33/26

(52) U.S. Cl. CPC H05B 33/145; H05B 33/26

(57) ABSTRACT

A coplanar electrode arrangement is provided for an electroluminescent device. The electroluminescent device is comprised of: an array of driving cells formed in a tessellated arrangement on a planar surface of the substrate; and an electroluminescent material deposited onto the array of unit cells. Each driving cell in the array of driving cells is comprised of a core electrode surrounded by and coplanar with a peripheral electrode, such that the peripheral electrode is separated from the core electrode by an insulating material. The luminescent material emits light when a voltage is applied across the electrodes.

### CROSS-REFERENCE TO RELATED APPLICATIONS

This application claims the benefit of U.S. Provisional Application No. 62/212,055, filed on Aug. 31, 2015. The entire disclosure of the above application is incorporated herein by reference.

### FIELD

The present disclosure relates to luminescent displays and lighting panels.

### BACKGROUND

Electroluminescence is the emission of light from a material in response to an electric current or an electric field. In a typical construct, electroluminescent device are formed by sandwiching a luminescent material between two electrode plates. Because the luminescent material is sandwiched between the two electrodes, one or both of the electrode layers need to be transparent in order to emit light. The process for making transparent electrodes is both expensive and time consuming. Furthermore, the mismatch between mechanical and thermal properties of materials in the conventional stacked arrangement causes stress within the device. This stress in turn accelerates degradation and thereby shortens the life of the device. The conventional stacked arrangement is also not very scalable.

Therefore, it is desirable to develop an improved electrode arrangement for constructing an electroluminescent device which overcomes the deficiencies of the known devices.

This section provides background information related to the present disclosure which is not necessarily prior art.

### SUMMARY

This section provides a general summary of the disclosure, and is not a comprehensive disclosure of its full scope or all of its features.

A coplanar electrode arrangement is presented for an electroluminescent device. The electroluminescent device includes: a substrate; and an array of unit cells formed in a tessellated arrangement on a planar surface of the substrate. Each unit cell is comprised of a core electrode surrounded by a peripheral electrode, such that the peripheral electrode is separated from the core electrode by an insulating material. An electroluminescent material deposited onto the array of unit cells.

Each peripheral electrode in the array of unit cells can have a shape selected from a group consisting of a triangle, a square, and a hexagon.

Each unit cell in the array of unit cells is configured to have a voltage difference applied across the core electrode and the peripheral electrode. In one embodiment, each unit cell in the array of unit cells is individually energized. The magnitude of voltage applied to the core electrodes may result in an electric field having a value in range of 10⁴-10⁷ volts per centimeter.

An insulating film may be disposed between the array of unit cells and the electroluminescent material.

The electroluminescent material is selected from II-VI group of emissive materials. For example, the electroluminescent material can be zinc sulfide with trace amounts of doping elements.

In another aspect, the electroluminescent device includes: a substrate; and an array of driving cells formed on a planar surface of the substrate and arranged abutting each other. In one embodiment, each driving cell being comprised of a core electrode and a peripheral electrode, wherein the peripheral electrode is coplanar with a top portion of the core electrode and an insulating material separates the lower portion of the core electrodes from each other. Each driving cell in the array of driving cells is configured to have a voltage difference applied across the core electrode and the peripheral electrode. Lastly, an electroluminescent material is deposited onto the array of unit cells and interposed between the peripheral electrode and the top portion of the core electrode in each of the driving cells in the array of driving cells.

In yet another aspect, the electroluminescent device includes: a substrate; and an array of driving cells formed on a planar surface of the substrate and arranged abutting each other. Each driving cell is comprised of a core electrode and a peripheral electrode, where the peripheral electrode is coplanar with a portion of the core electrode and the peripheral electrode is separated from the coplanar portion of the core electrode by one of an insulating material, an electroluminescent material or a media containing the electroluminescent material. Each driving cell in the array of driving cells is also configured to have a voltage difference applied across the core electrode and the peripheral electrode.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a perspective view of an electroluminescent device constructed in accordance with this disclosure;

FIG. 1B is a perspective view of the electroluminescent device with a partial cutaway of the electroluminescent layer;

FIG. 2 is a top view of the electroluminescent device;

FIGS. 3A and 3B are cross-sectional side views of the electroluminescent device with the peripheral electrode coplanar with and offset from the core electrode, respectively;

FIGS. 4A and 4B are diagrams depicting different configurations for the peripheral electrode in the electroluminescent device;

FIG. 4C is a diagram depicting a core electrode with features designed to shape the electric field;

FIG. 5 is a flowchart illustrating an example method for fabricating the electroluminescent device;

FIGS. 6A and 6B are cross-sectional side views of alternative embodiments of an electroluminescent device having electrodes separated by electroluminescent material; and

FIG. 7 is an example of a luminescent display which incorporates the electroluminescent device described in this disclosure.

Corresponding reference numerals indicate corresponding parts throughout the several views of the drawings.

### DETAILED DESCRIPTION

Example embodiments will now be described more fully with reference to the accompanying drawings.

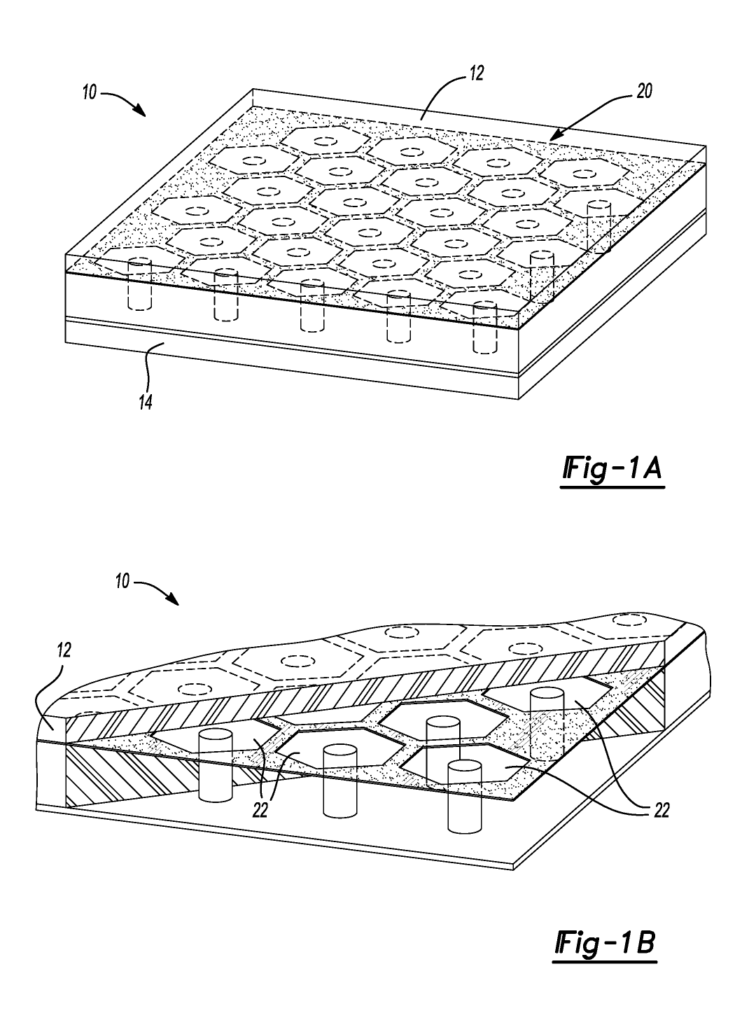

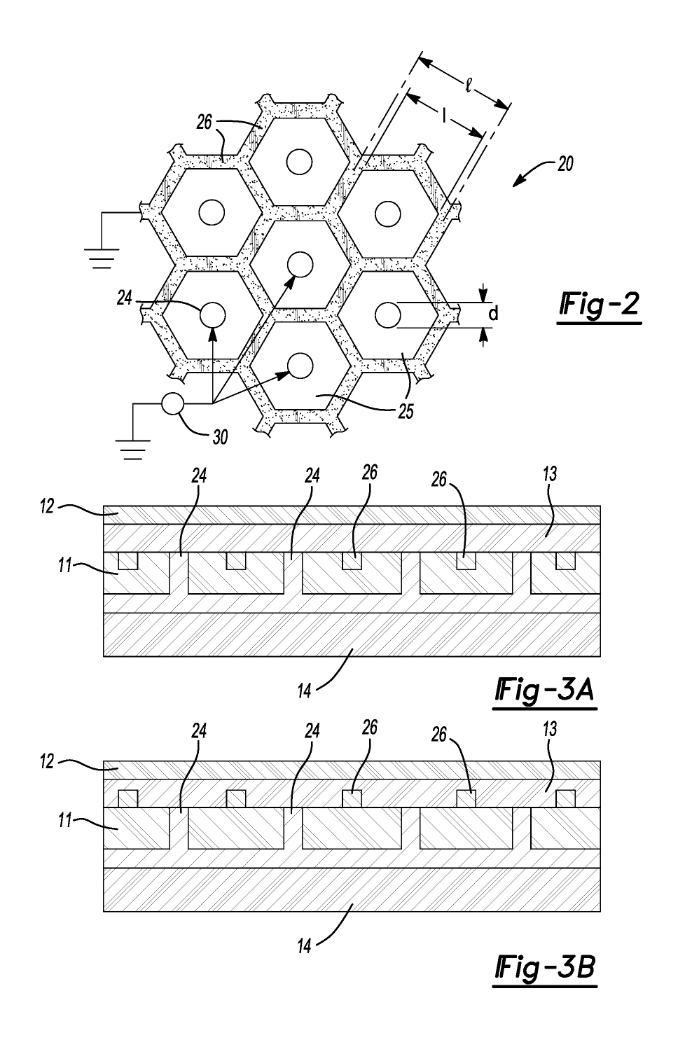

FIGS. 1-3 depict an example embodiment of an electroluminescent device 10 constructed in accordance with this disclosure. The electroluminescent device 10 is comprised generally of an electroluminescent material 12, an array of the driving (unit) cells 20 and a substrate 14. The array of driving cells 20 is formed in a tessellated arrangement on a planar surface of the substrate 14. That is, the driving cells 20 are arranged abutting each other with no overlap or gaps between cells.

Each driving cell 22 includes a core electrode 24 surrounded by a peripheral electrode 26. In an example embodiment, at least a top portion of the core electrode 24 is coplanar with the peripheral electrode 26 as best seen in FIG. 3A. In other embodiments, peripheral electrode 26 is offset from the core electrode 24 and positioned in a plane above the plane formed by the core electrodes as seen in FIG. 3B. The electrodes 24, 26 may be made of gold, silver, aluminum, platinum, palladium as well as other metals or other types of conductive materials, such as glassy carbon, graphite, graphene, indium tin oxide and fluorine doped tin oxide.

In FIG. 3A, core electrode 24 is separated from the peripheral electrode 26 by an insulating material 11. In FIG. 3B, the core electrodes 24 are separated from each other by the insulating material 11. The peripheral electrodes 26 are in turn disposed onto the insulating material 11, thereby forming the array of driving cells 20. The electroluminescent material 12 is then disposed onto the array of driving cells 20.

Referring to FIGS. 3A and 3B, an additional thin layer 13 of insulating material may be disposed between the electroluminescent material 12 and the array of the driving cells 20. In FIG. 3B, the insulating later 13 separates the peripheral electrodes 26 from each other as well as the peripheral electrodes 26 from the electroluminescent material 12. The insulating layer 13 is intended to prevent electric discharges between the electrodes in the driving cells 20. In other embodiments, the additional insulating layer may be omitted from the device. Example materials for the insulating material 11 and insulating layer 13 include but are not limited to epoxies (e.g., polymethyl methacrylate (PMMA) or polydumethylsiloxane (PDMS)), urethanes, silicones, metal-oxides such as alumina as well as other photoresist materials (e.g., SU-8). Other types of insulating materials are also contemplated by this disclosure.

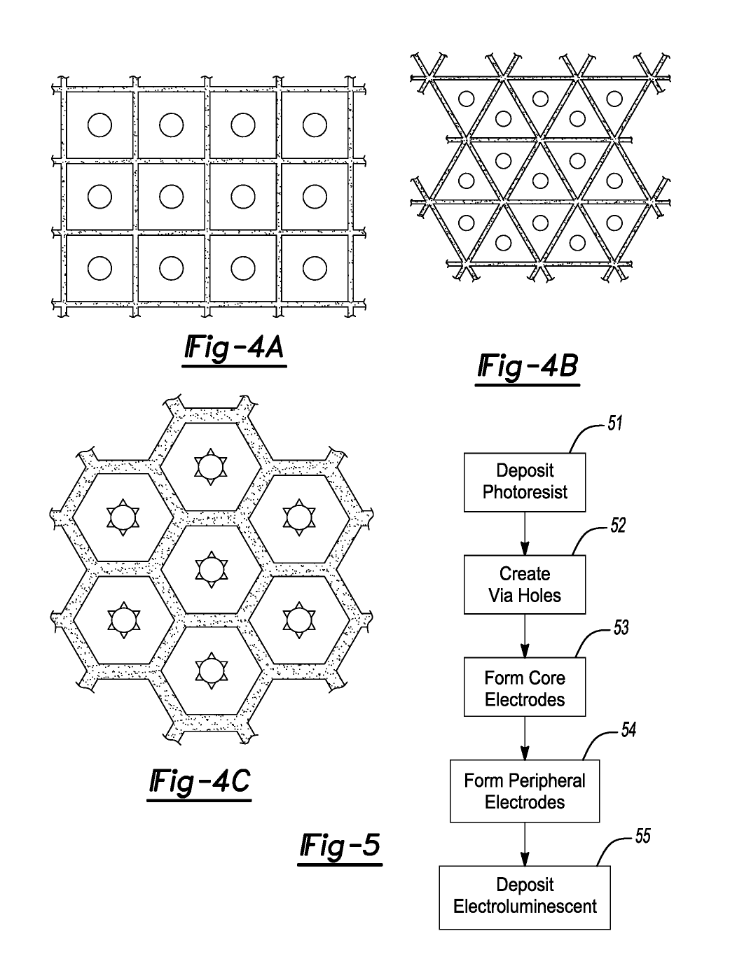

In the example embodiment, the peripheral electrodes 26 are in the shape of a hexagon while the core electrode 24 in the shape of a circle. The peripheral electrodes 26 may take on other shapes including squares or triangles as shown in FIGS. 4A and 4B, respectively. Likewise, the core electrode 24 may take on other shapes, such as hexagons. In some embodiments, sub-features may be added to either the peripheral electrodes or the core electrodes or both. For example, spikes that protrude outward from the core electrodes 24 may be used to concentrate the electric field lines as seen in FIG. 4C. The peripheral electrodes 26 preferably have the same size and geometric shape as seen in the example embodiment. It is also envisioned that the array of driving cells 20 may be comprised of driving cells 22 having different sizes and/or different shapes.

Dimensions for a given driving cell 22 may be characterized by “d” the diameter of the core electrode 24 and “I” the diameter of a circle inscribed in the peripheral electrode 26. In the example embodiment, d is 50 micrometers and l is 150 micrometers. While the example embodiment has been described above with specific components having specific values and arranged in a specific configuration, it will be appreciated that the electroluminescent device 10 may be constructed with many different configurations, components, and/or values as necessary or desired for a particular application. The above configurations, components and values are presented only to describe one particular embodiment that has proven effective and should be viewed as illustrative, rather than limiting.

Various types of organic and inorganic electroluminescent materials are contemplated for use in the electroluminescent device 10. In the example embodiment, the electroluminescent material 12 is selected from II-VI group of emissive materials. For example, the electroluminescent material 12 may be a zinc sulfide doped with manganese (e.g., 800-3500 ppm), zinc sulfide doped with copper (e.g., 400-1500 ppm), chlorine (e.g., 100 ppm) or bromine (e.g., 400 ppm). Other types of emissive materials from this grouping as well as other types of dopants also fall within the scope of this disclosure. The electroluminescent material 12 may be deposited into the array of driving cells 20 by spray-coating, vapor deposition as well as other known fabrication methods.

In other examples, the electroluminescent material 12 may be comprised of organic light emitting molecules and conjugated polymers, such as anthracene doped with tetracene or pentacene, gonacrin, brilliant acridine orange E, carbazole, and conjugated polymers such as polyphenylene vinlene, poly p-phenylene or poly 3-alkylthiophenes. The electroluminescent material 12 may also be comprised of semiconducting nanocrystals or quantum dots of core-shell construction, such as nanoparticles with a CdSe core and a doped ZnS shell. In yet other embodiments, the electroluminescent material 12 may be selected from the III-V group of materials, including GaAs, InP GaP and GaN.

Alternately, luminescence in the electroluminescent device 10 may occur due to electro-generated chemiluminescence (ECL). In this mechanism, light emission is due to a high energy electron transfer reaction between chemical species that are generated when voltage is applied to the electrodes. Light is produced from the recombination of the excited species of opposing polarity, or as a result of reaction with other auxiliary chemicals present in the media. However, since the lifetime of the electrically generated excited species is fairly short—less than a fraction of a second—the electrodes must be in close proximity in order for the luminous recombination of the excited species to occur before they decay or relax through other non-radiative routes. The tessellated electrode patterns disclosed here are useful in that the anode and cathode electrodes are uniformly meshed across the entire energized surface. In one embodiment, luminescent materials consisting of metal chelates such as tris(bipyridine)ruthenium(II) [Ru(bpy)₃]²⁺ undergo continuous oxidation and reduction at the electrodes in the presence of an auxiliary reactant such as tripropylamine (TPA) to produce light. In another embodiment, semiconductor quantum dots, such as CdSe and CdS, in combination with auxiliary reactants such as oxalates (C₂O₄²⁻), hydrogen peroxide (H₂O₂), sulfites (SO₃²⁻) and peroxydisulfates (S₂O₈²⁻) produce light in proximity to the energized electrodes. It is readily understood that luminescence due to ECL may result from other comparable materials as well.

To illuminate the electroluminescent material, each driving cell 22 in the array of driving cells 20 is configured to have a voltage difference applied across the core electrode and the peripheral electrode. In the example embodiment, each of the core electrodes 24 is electrically coupled to a single voltage source 30; whereas, each of the peripheral electrodes 26 are electrically coupled to ground 31 (i.e., zero voltage). In some embodiments, the peripheral electrodes may be electrically coupled to a single voltage source and the core electrodes may be electrically coupled to ground. In other embodiments, there may be multiple voltage sources coupled to each driving cell such that each driving cell is individually addressable. For example, a different voltage source may be applied to each core electrode while peripheral electrodes are maintained at a constant voltage (e.g., zero voltage). The applied voltage signal may take different forms including but is not limited to sine wave, square wave, triangle wave, sawtooth wave or combinations thereof as well as pulses with the same or reverse polarities.

Depending on the dimensions of the driving cells 22, the magnitude of the applied voltage is set to achieve a desired electric field strength. Electric field strength in the range of 10⁴-10⁷ volts per centimeter is typically required to excite the electroluminescent material. Accordingly, in the example embodiment, the applied voltage is an AC voltage with a magnitude in the range of 0.1 to 1000 volts and an oscillating frequency in the range of 0.1 Hz to 100 kHz. In some embodiments, the applied voltage may be pulses of DC voltage. In any case, it is understood that the magnitude of the applied voltage can vary to achieve the desired electric field strength.

An example method for fabricating the electroluminescent device 10 is further described in relation to FIG. 5. A photoresist, such as SU8 or PMMA, is first deposited at 51 onto a metal surface of a metallized substrate. The photoresist is patterned and etched at 52 to create via holes terminating at the underlying metal surface. The core electrodes 24 (i.e., pillars) are formed at 53 by filling up the via holes with a metal up to the top surface of the photoresist, for example by electro-plating. The peripheral electrodes 26 can be formed in the photoresist as indicated at 54. Example methods for forming the peripheral electrodes 26 include printing the pattern onto the photoresist or metal patterning in combination with a lift-off method. Lastly, the electroluminescent material is deposited at 55 onto the array of driving cells. Prior to depositing the electroluminescent material, an insulating layer 13 may optionally be deposited onto the array of driving cells.

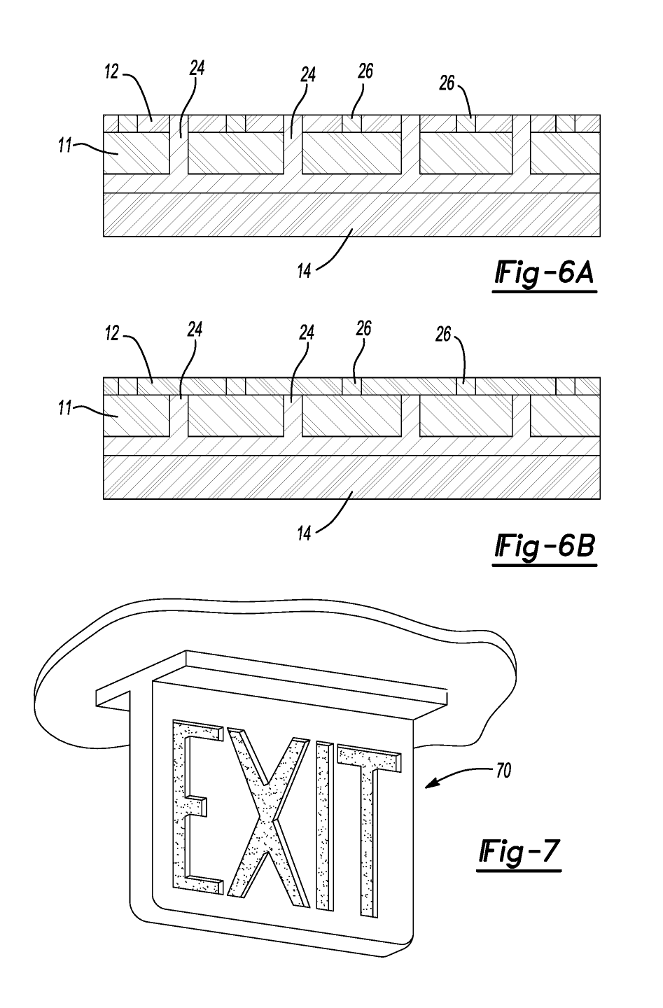

FIGS. 6A and 6B depict another variant of an electroluminescent device 60. In FIG. 6A, the peripheral electrodes 26 are coplanar with the core electrodes 24. More specifically, the peripheral electrode 26 is separated from a top portion of the core electrode 24 by the electroluminescent material 12; whereas, the lower portion of the core electrodes 24 are separated from each other by the insulating material 11. That is, the electroluminescent material 12 (or a media contained luminescent material) is disposed between the electrodes 24, 26.

In FIG. 6B, the peripheral electrodes 26 are offset from the core electrodes 24. In this arrangement, the peripheral electrodes 26 are separated from each other by the electroluminescent material 12; whereas, the entirety of the core electrodes 24 are separated from each other by the insulating material 11. Except with respect to the differences discussed herein, the construct and operation of the electroluminescent device 60 is substantially the same as the electroluminescent device 10 described above.

FIG. 7 depicts an example light panel 70 which can employ the electroluminescent device 10 described above. It is understood that the electroluminescent device 10 can be integrated into a variety of different types of displays and light panels. Applications for the electroluminescent device 10 include but are not limited to nightlights, decorative luminescent clothing, watch illumination, flat wall decorative illumination, durable waterproof displays, medical tool display screens, computer monitors and billboards. The tessellated electrode arrangements are also useful for electrodes used in electrochemistry, sensors and actuators.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electroluminescent device, comprising:
a substrate;
an array of unit cells formed in a tessellated arrangement on a planar surface of the substrate, each unit cell being comprised of a core electrode surrounded by a peripheral electrode, such that the peripheral electrode is separated from the core electrode by an insulating material; and
an electroluminescent material deposited onto the array of unit cells.

2. The electroluminescent device of claim 1 wherein each unit cell in the array of unit cells has the same geometric shape.

3. The electroluminescent device of claim 1 wherein each peripheral electrode in the array of unit cells has a shape selected from a group consisting of a triangle, a square, and a hexagon.

4. The electroluminescent device of claim 1 wherein each unit cell in the array of units cells is configured to have a voltage difference applied across the core electrode and the peripheral electrode.

5. The electroluminescent device of claim 1 wherein each unit cell in the array of units cells is individually energized.

6. The electroluminescent device of claim 1 wherein at least one of a core electrode and a peripheral electrode in each unit cell in the array of unit cells is electrically coupled to a voltage source, and the other of the core electrode or the peripheral electrode in each unit cell in the array of unit cells is electrically coupled to ground.

7. The electroluminescent device of claim 1 further comprises a voltage source electrically coupled to core electrode in each unit cell in the array of unit cells wherein magnitude of voltage applied to the core electrodes results in an electric field having a value in range of 10⁴-10⁷ volts per centimeter.

8. The electroluminescent device of claim 1 further comprises an insulating film disposed between the array of unit cells and the electroluminescent material.

9. The electroluminescent device of claim 1 wherein the electroluminescent material is selected from II-VI group of emissive materials.

10. The electroluminescent device of claim 1 wherein the wherein the electroluminescent material is zinc sulfide with trace amounts of doping elements.

11. An electroluminescent device, comprising:
a substrate;
an array of driving cells formed on a planar surface of the substrate and arranged abutting each other, each driving cell being comprised of a core electrode and a peripheral electrode, wherein the peripheral electrode is coplanar with a top portion of the core electrode and an insulating material separates the lower portion of the core electrodes from each other;
each driving cell in the array of driving cells is configured to have a voltage difference applied across the core electrode and the peripheral electrode;
an electroluminescent material deposited onto the array of unit cells and interposed between the peripheral electrode and the top portion of the core electrode in each of the driving cells in the array of driving cells.

12. The electroluminescent device of claim 11 wherein each driving cell in the array of driving cells has the same geometric shape.

13. The electroluminescent device of claim 12 wherein each core electrode in the array of driving cells has a circle shape and each peripheral electrode in the array of driving cells has a shape selected from a group consisting of a triangle, a square, and a hexagon.

14. The electroluminescent device of claim 13 wherein the core electrode in each driving cell in the array of unit cells is electrically coupled to a voltage source, and the peripheral electrode in each driving cell in the array of driving cells is electrically couple to ground.

15. The electroluminescent device of claim 11 wherein each unit cell in the array of units cells is individually energized.

16. The electroluminescent device of claim 14 wherein the voltage source applies a voltage to the core electrode having a magnitude set to a value that creates an electric field having a value in range of 10⁴-10⁷ volts per centimeter.

17. The electroluminescent device of claim 11 wherein the electroluminescent material is selected from II-VI group of emissive materials.

18. The electroluminescent device of claim 11 wherein the electroluminescent material is zinc sulfide with trace amounts of doping elements.

19. An electroluminescent device, comprising:
a substrate;
an array of driving cells formed on a planar surface of the substrate and arranged abutting each other, each driving cell being comprised of a core electrode and a peripheral electrode, wherein the peripheral electrode is coplanar with a portion of the core electrode and the peripheral electrode is separated from the coplanar portion of the core electrode by one of an insulating material, an electroluminescent material or a media containing the electroluminescent material; and
each driving cell in the array of driving cells is configured to have a voltage difference applied across the core electrode and the peripheral electrode.
